(19) United States
(12) Patent Application Publication
(10) Pub. No.: US 2006/0063906 A1
(43) Pub. Date: Mar. 23, 2006

(54) Process for the preparation of polycarbonate

(76) Inventors: Ulrich Blaschke, Krefeld (DE); Stefan Westernacher, Kempen (DE); Wolfgang Ebert, Krefeld (DE); Rainer Neumann, Bad Tolz (DE)

Correspondence Address: BAYER MATERIAL SCIENCE LLC, 100 BAYER ROAD, PITTSBURGH, PA, 15205, US

(21) Appl. No.: 11/226,093

(22) Filed: Sep. 14, 2005

(30) Foreign Application Priority Data
Sep. 22, 2004 (DE) 102004045822.7

(51) Int. Cl. C08G 64/00

(52) U.S. Cl. 528/196

(57) ABSTRACT

A process for the preparation of polycarbonate by the phase interface process is disclosed. The process includes (a) preparing a sodium hydroxide solution by chloralkali electrolysis, the solution containing not more than 30 ppm sodium chlorate relative to the weight of sodium hydroxide, and (b) reacting an aqueous solution of said sodium hydroxide with at least one dihydoxydiarylalkane to obtain a solution of disodium salt and (c) reacting said solution of disodium salt with phosgene in the presence of at least one organic solvent, a chain terminator and optionally a branching agent to obtain an oligocarbonate, and (d) condensing the oligocarbonate in the presence of at least one catalyst to obtain a material system containing polycarbonate and organic solvent and (e) separating off of the organic phase from said material system. The polycarbonate prepared by the inventive process is characterized by its low yellowness index.

### FIELD OF THE INVENTION

The invention relates to a process and in particular to a process for the preparation of polycarbonate.

### BACKGROUND OF THE INVENTION

Polycarbonate is prepared, inter alia, by the known phase interface process, in which dihydroxydiarylalkanes (bisphenols) in the form of their alkali metal salts (bisphenolates) are reacted with phosgene in a heterogeneous phase system in the presence of inorganic bases, such as caustic soda solution, and an organic solvent in which the product, polycarbonate, is readily soluble. Two phases are therefore present, an aqueous and organic phases. After the reaction, the organic phase containing polycarbonate is washed with an aqueous liquid, during which, inter alia, electrolytes are removed, and the wash liquid is separated off.

For the preparation of polycarbonate based on bisphenol A, bisphenol A is dissolved or suspended in caustic soda solution to form sodium bisphenolate. In this case, the purity of the caustic soda solution used for the preparation of the sodium bisphenolate solution is decisive for the purity of the polycarbonate prepared therefrom. DE 199 52 848 A, for example, describes a process for the preparation of polycarbonate in which the caustic soda solution employed has a low content of certain metals and the water employed is completely desalinated.

It is furthermore known that oxygen has a damaging effect on sodium bisphenolate solutions. Oxidation of (bis)phenolic compounds leads to coloration of the sodium bisphenolate solutions. This coloration is also evident in the end product, polycarbonate, and is undesirable for uses where transparency of the polycarbonate and the absence of color therefrom are important. Thus, DE 198 59 690 A describes a process for the preparation of sodium bisphenolate solutions having a content of dissolved oxygen of less than 150 ppb, in which bisphenols are reacted with an aqueous NaOH solution having a content of dissolved oxygen of less than 100 ppb with exclusion of oxygen.

The object of the present invention accordingly is to provide a process for the preparation of polycarbonate by the phase interface process in which the quality of the polycarbonate, in particular in respect of its color, is not impaired.

### SUMMARY OF THE INVENTION

A process for the preparation of polycarbonate by the phase interface process is disclosed. The process includes (a) preparing a sodium hydroxide solution by chloralkali electrolysis, the solution containing not more than 30 ppm sodium chlorate relative to the weight of sodium hydroxide, and (b) reacting an aqueous solution of said sodium hydroxide with at least one dihydoxydiarylalkane to obtain a solution of disodium salt and (c) reacting said solution of disodium salt with phosgene in the presence of at least one organic solvent, a chain terminator and optionally a branching agent to obtain an oligocarbonate, and (d) condensing the oligocarbonate in the presence of at least one catalyst to obtain a material system containing polycarbonate and organic solvent and (e) separating off of the organic phase from said material system. The polycarbonate prepared by the inventive process is characterized by its low yellowness index.

### DETAILED DESCRIPTION OF THE INVENTION

It has been found that a certain content of chlorate which is contained in the aqueous sodium hydroxide solution (caustic soda solution) of a disodium salt of a dihydroxydiarylalkane leads to an impairment of the color of the sodium bisphenolate solution and therefore also of the polycarbonate.

The present invention accordingly provides a process for the preparation of polycarbonate by the phase interface process, comprising at least the following steps:
(a) reaction of an aqueous sodium hydroxide solution of a disodium salt of at least one dihydroxydiarylalkane with phosgene in the presence of at least one organic solvent, a chain terminator and optionally a branching agent
(b) condensation of the oligocarbonates, prepared according to step (a), in the presence of at least one catalyst
(c) separating off of the organic phase containing polycarbonate obtained according to step (b),
   a sodium hydroxide solution which contains not more than 30 ppm, preferably not more than 10 ppm sodium chlorate, based on 100 wt. % sodium hydroxide being employed.

The present invention also provides a process for the preparation of an aqueous sodium hydroxide solution of at least one dihydroxydiarylalkane by reaction of a dihydroxydiarylalkane with an aqueous sodium hydroxide solution, the dihydroxydiarylalkane being in the form of a solid and/or melt. This process is characterized in that the sodium hydroxide solution contains not more than 30 ppm, preferably not more than 10 ppm sodium chlorate, based on 100 wt. % sodium hydroxide.

The sodium hydroxide solution used in the process according to the invention generally contains sodium chlorate as impurity. The content of sodium chlorate is >0 ppm, preferably >0.1 ppm (based on 100 wt. % sodium hydroxide).

In the context of the present invention, an aqueous sodium hydroxide solution of a disodium salt of at least one dihydroxydiarylalkane is also understood as meaning an aqueous sodium hydroxide suspension of the dihydroxydiarylalkane or of its disodium salt.

The preparation according to the invention of polycarbonate comprising steps (a) to (c) and the preparation according to the invention of an aqueous sodium hydroxide solution of at least one dihydroxydiarylalkane are preferably carried out under inert conditions.

In the context of the present invention, inert conditions are understood as meaning an oxygen content of not more than 20 ppb in the sodium hydroxide solution and in any water employed, the work being carried out with substantial exclusion of oxygen. The working with exclusion of oxygen is preferably carried out as described in DE 199 43 640 A and DE 198 59 690 A (CA 2384432 and U.S. Pat. No. 6,395,864 respectively, incorporated herein by reference).

Use of the dihydroxydiarylalkane as a melt is understood as meaning both direct use of the melt from the preparation of the dihydroxydiarylalkane without prior solidification and indirect use of a re-melted dihydroxydiarylalkane after solidification, for example in the form of prills or flakes.

The phase interface process for the preparation of polycarbonate comprising steps (a) to (c) is known. The process and solvents, catalysts, chain terminators and branching agents which may be employed therein and molecular weights of the polycarbonates are described, for example, in EP 411 433 A, EP 894 816 A or EP 1 352 925 A (U.S. Pat. Nos. 5,104,964; 5,283,314; 6,166,167 and 6,797,837 all incorporated herein by reference).

In the process according to the invention for the preparation of polycarbonate, caustic soda solution which contains not more than 30 ppm, preferably not more than 10 ppm sodium chlorate, based on 100 wt. % sodium hydroxide, is employed. The use of such a caustic soda solution relates to all the steps of the process in which caustic soda solution is employed. Thus, a sodium hydroxide solution which contains not more than 30 ppm sodium chlorate is used in the preparation of the aqueous sodium hydroxide solution of a disodium salt of at least one dihydroxydiarylalkane which is employed in step (a) (also called dihydroxydiarylalkane solution in the following). Furthermore, caustic soda solution which contains not more than 30 ppm sodium chlorate may additionally be added for the polycarbonate reaction (steps (a) and (b)). Such a caustic soda solution may also be used for dissolving a branching agent.

Caustic soda solution having a maximum content of 30 ppm sodium chlorate is likewise employed in the process according to the invention for the preparation of an aqueous sodium hydroxide solution of at least one dihydroxydiarylalkane. The process according to the invention also includes an embodiment in which a dilute solution of the dihydroxydiarylalkane is first prepared from at least one dihydroxydiarylalkane and caustic soda solution and is then brought to a higher concentration by addition of further dihydroxydiarylalkane. The aqueous sodium hydroxide solution of the disodium salt is prepared by bringing the dihydroxydiarylalkane into contact with caustic soda solution. In this procedure, the dihydroxydiarylalkane may be in a solid form, such as, for example, prills or flakes, or in the form of a melt. The dihydroxydiarylalkane may also first be brought into contact with water and only then with the caustic soda solution.

The concentration of the solution, prepared according to the invention, (of the disodium salt) of a dihydroxydiarylalkane is 3 to 25 wt. %, preferably 5 to 20 wt. %, particularly preferably 10 to 18 wt. % dihydroxydiarylalkane (or sum of dihydroxydiarylalkanes), based on the total dihydroxydiarylalkane solution.

The caustic soda solution is preferably employed in the processes according to the invention as a 2 to 55 wt. % strength, particularly preferably as a 5 to 35 wt. % strength solution.

If the caustic soda solution is present in a higher concentration, it is first diluted, preferably with completely desalinated water, called CD water in the following. The CD water is preferably desalinated, degassed and optionally desilicified. The electrical conductivity of the CD water serves as a quality criterion. Electrical conductivity of not more than 0.2 μS/cm and an SiO₂ concentration of not more than 0.02 mg/kg are preferred (see also DE 19 952 848 A and DE 198 59 690 A corresponding to U.S. Pat. No. 6,835,798 and U.S. Pat. No. 6,395,864, both incorporated herein by reference).

Furthermore, the CD water, the caustic soda solution and/or the dihydroxydiarylalkane solution are preferably filtered at least once, particularly preferably twice to three times before the start of the reaction. Various filter types having pore sizes of, for example, 0.25 to 100 μm may be employed for this. In particular the CD water is filtered twice, for example bag and/or candle filters having a pore size of 1 μm being used. Preferably, the dihydroxydiarylalkane solution is first filtered once with polypropylene filters (pore size 50 μm) and then twice with bag filters (5 μm and 1 μm pore size), before use in the synthesis of the polycarbonate.

The content of other impurities in the caustic soda solution is preferably also as low as possible.

In particular, other substances having an oxidative action, such as perchlorate, should be present to the extent of not more than 30 ppm, particularly preferably not more than 10 ppm (based on 100 wt. % sodium hydroxide).

Moreover, the content of sulfates, carbonates and chlorides in the caustic soda solution should preferably also be as low as possible. Not more than 120 ppm chloride, not more than 80 ppm sulfate and not more than 300 ppm carbonate (based on 100 wt. % sodium hydroxide) are preferred here.

A caustic soda solution having a maximum content of 30 ppm sodium chlorate may be prepared either directly with such a sodium chlorate content, or indirectly, by first obtaining a caustic soda solution having a higher content of sodium chlorate, the sodium chlorate content of which is then lowered.

Processes for the preparation of caustic soda solution are adequately known. A familiar process is chloralkali electrolysis, a distinction being made between the amalgam process, the membrane process and the diaphragm process. The latter have the advantage over the amalgam process that no mercury is employed. In addition to the lower power consumption, the content of metals in the caustic soda solution obtained is moreover lower in the membrane process. On the other hand, a disadvantage of the membrane and diaphragm process is that the separation of the anode chamber and cathode chamber is no longer completely ensured. In the diaphragm process in particular, but also to a lesser extent in the membrane process, chlorate is formed by the contact between the chlorine and the caustic soda solution.

Accordingly, in one embodiment of the process according to the invention, the caustic soda solution is prepared by means of the amalgam process. Such a caustic soda solution contains not more than 30 ppm sodium chlorate.

If the caustic soda solution contains more than 30 ppm sodium chlorate, based on 100 wt. % sodium hydroxide, after its preparation, for example by means of the diaphragm or membrane process of chloralkali electrolysis, the content of sodium chlorate may be lowered e.g. by mixing with a caustic soda solution having a lower content of sodium chlorate, for example prepared by the amalgam process.

Thus, for example, caustic soda solution having a sodium chlorate content of not more than 30 ppm, based on 100 wt. % sodium hydroxide, may be obtained by mixing 50 parts of caustic soda solution from the membrane process (for example 15 ppm sodium chlorate, based on 100 wt. % sodium hydroxide) with 50 parts of caustic soda solution from the diaphragm process (for example 45 ppm sodium chlorate, based on 100 wt. % sodium hydroxide).

Furthermore, the content of sodium chlorate in the caustic soda solution may be lowered by lowering the content of sodium chlorate in the brine of the chloralkali electrolysis by chlorate decomposition in the brine circulation. By acidification of the brine, for example with hydrochloric acid, the chlorate synproportionates with the chloride to form chlorine. Brine circulation is understood here as meaning the concentration of the brine remaining in the electrolysis with NaCl and recycling thereof into the electrolysis. In this procedure, acidification may take place for removal of chlorate from the total amount of brine or also only from portions of the brine.

In a further embodiment, the content of sodium chlorate is also lowered in a controlled manner in the caustic soda solution itself, for example by treatment with inorganic reducing agents (e.g. sodium sulfite or sodium dithionite) or with organic reducing agents (e.g. formaldehyde), by catalytic reduction with hydrogen or by removal by means of suitable ion exchangers or a combination of these methods.

In addition, the content of chlorate in the brine may be lowered by feeding out from the brine circulation. To minimize the unprofitability of such a process, such a brine originating from a membrane or diaphragm process may be used in an amalgam process after any concentration with NaCl.

In the preparation of polycarbonate using a caustic soda solution having a maximum content of sodium chlorate of 30 ppm, a polycarbonate is formed which has a lower intrinsic coloration, and therefore has a lower yellowness index (YI) as a measure of the color, compared with a polycarbonate which has been prepared with a caustic soda solution having a higher sodium chlorate content.

Preferred starting substances for the preparation of the sodium hydroxide solution of at least one dihydroxydiarylalkane are: dihydroxydiarylalkanes of the general formula HO-Z-OH, wherein Z is a divalent organic radical having 6 to 30 carbon atoms, which contains one or more aromatic groups. Examples of such compounds are bisphenols which belong to the group of dihydroxydiphenyls, bis(hydroxyphenyl)alkanes, indanebisphenols, bis(hydroxyphenyl) ethers, bis(hydroxyphenyl) sulfones, bis(hydroxyphenyl) ketones and α,α′-bis(hydroxyphenyl)diisopropylbenzenes.

Particularly preferred bisphenols which belong to the abovementioned compound groups are 2,2-bis-(4-hydroxyphenyl)propane (bisphenol A (BPA)), tetraalkylbisphenol A, 4,4-(meta-phenylenediisopropyl)diphenol (bisphenol M), 1,1-bis-(4-hydroxyphenyl)-3,3,5-trimethylcyclohexane and optionally mixtures thereof. Particularly preferred copolycarbonates are those based on the monomers bisphenol A and 1,1-bis-(4-hydroxyphenyl)-3,3,5-trimethylcyclohexane. The bisphenol compounds to be employed according to the invention are reacted with carbonic acid compounds, in particular phosgene.

Furthermore, some, i.e. not more than 80 mol %, preferably 20 to 50 mol % of the carbonate groups in the polycarbonates may be replaced by aromatic dicarboxylic acid ester groups.

### EXAMPLES

### Example 1

A 15% strength sodium bisphenolate solution was prepared from solid bisphenol A and a chlorate-free 6.5% strength caustic soda solution which had been rendered inert. After addition of 0 ppm, 10 ppm and 100 ppm sodium chlorate, based on the bisphenol (corresponding to 0 ppm, 27 ppm and 270 ppm, based on 100 wt. % sodium hydroxide), the mixture was stirred under nitrogen for 5 hours at 65° C. The UV-VIS spectra were then measured with a Varian Cary 1 E UV spectrometer at a layer thickness of 5 cm.

TABLE 1
Absorption as a function of the wavelength (in nm) and
the content of chlorate (in ppm sodium chlorate)

| | 100 ppm | 10 ppm | 0 ppm |
|---|---|---|---|
| Wavelength/nm | sodium chlorate | sodium chlorate | sodium chlorate |
| 800 | 0.0829 | 0.0793 | 0.0772 |
| 750 | 0.1008 | 0.0967 | 0.0936 |
| 700 | 0.0603 | 0.0552 | 0.0516 |
| 650 | 0.0598 | 0.0535 | 0.0504 |
| 600 | 0.0653 | 0.0572 | 0.0546 |
| 550 | 0.0845 | 0.0759 | 0.0730 |
| 500 | 0.1126 | 0.1005 | 0.0956 |
| 450 | 0.1577 | 0.1386 | 0.1311 |
| 400 | 0.2879 | 0.2582 | 0.2493 |

It may be seen from Table 1 that at a higher sodium chlorate content the absorption, i.e. depth of color, of the sodium bisphenolate solution increases.

### Example 2

For preparation of a polycarbonate, bisphenol A was mixed into caustic soda solution with exclusion of oxygen, bisphenol A being employed as a melt. The caustic soda solution was 32 wt. % strength and contained 5 ppm sodium chlorate (16 ppm, based on 100 wt. % sodium hydroxide). To dissolve the bisphenol, the caustic soda solution was diluted with CD water to a 6.5% strength caustic soda solution. After filtration, this sodium bisphenolate solution was employed in the phase interface polycarbonate reaction as described in the literature cited. After the reaction, the reaction solution, containing polycarbonate, chlorobenzene and methylene chloride, was filtered and fed to washing. It was washed with hydrochloric acid and then washed several times with filtered CD water, until the wash water had reached a conductivity of ≦10 μS/cm. The organic phase was separated off from the aqueous phases and filtered. The poly-2,2-bis-(4-hydroxyphenyl)-propane carbonate was isolated by distilling off the organic solvents. The polycarbonate had an average molecular weight of M_{w}=26,000. The yellowness index, as a measure of the colour, was YI=1.4.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for the preparation of polycarbonate by the phase interface process comprising
(a) preparing a sodium hydroxide solution by chloralkali electrolysis, the solution containing more than 0 ppm but not more than 30 ppm sodium chlorate relative to the weight of sodium hydroxide
(b) reacting an aqueous solution of said sodium hydroxide with at least one dihydoxydiarylalkane to obtain a solution of disodium salt
(c) reacting said solution of disodium salt with phosgene in the presence of at least one organic solvent, a chain terminator and optionally a branching agent to obtain an oligocarbonate,
(d) condensing the oligocarbonate in the presence of at least one catalyst to obtain a material system containing polycarbonate and organic solvent
(e) separating off of the organic phase from said material system.

2. The process according to claim 1 wherein the solution contains not more than 10 ppm of sodium chlorate.

3. The process according to claim 1 wherein the dihydroxydiarylalkane is at least one member selected from the group consisting of bisphenol A and 1,1-bis-(4-hydroxyphenyl)-3,3,5-trimethylcyclohexane.

4. The process according to claim 1 characterized in that it is carried out under inert conditions.

5. A process for the preparation of an aqueous sodium hydroxide solution of dihydroxydiarylalkane comprising
(i) preparing a sodium hydroxide solution by chloralkali electrolysis, the sodium chlorate contents of said solution being more than 0 ppm but not more than 30 ppm relative to the weight of sodium hydroxide, and
(ii) reacting at least one dihydroxydiarylalkane in the form of a solid and/or melt with said sodium hydroxide solution.

6. The process of claim 5 wherein said sodium chlorate contents is not more than 10 ppm.
